(19) United States
(12) Patent Application Publication
(10) Pub. No.: US 2007/0154182 A1
(43) Pub. Date: Jul. 5, 2007

(54) Signal pickup method and video/audio recording and playing system using the same

(76) Inventors: Chung-Song Kuo, Taipei (TW); Shih-Ming Chang, Taipei (TW); Meng-Tze Liu, Taipei (TW); Jiun-Kuei Jung, Taipei (TW); Fu-Sheng Chu, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/333,769

(22) Filed: Jan. 17, 2006

(30) Foreign Application Priority Data
Jan. 4, 2006 (TW) 095100353

(51) Int. Cl. H04N 7/00

(52) U.S. Cl. 386/96

(57) ABSTRACT

In a signal pickup method of a video/audio recording and playing system, a recording length and a tracing-back length are preset. An external signal is received and storing into a buffer of the video/audio recording and playing system. A designated section of the external signal is automatically picked up from the buffer according to the recording length and the tracing-back length in response to a triggering operation of a user.

### FIELD OF THE INVENTION

The present invention relates to a signal pickup method, and more particularly to a signal pickup method adapted to a video recording and playing system. The present invention also relates to a video/audio recording and playing system such as a computer system or a digital video/audio recorder.

### BACKGROUND OF THE INVENTION

When a computer system is used to play TV programs, the TV signals need be transformed into digital video signals such as MPEG signals by devices as exemplified in FIG. 1. First of all, a TV tuner card 19 is added to the computer system to communicate with a host 10 of the computer system via a bus 18. The bus 18, for example, can be a PCI bus, a USB bus or a Card bus. The TV signals received by the TV tuner card 19 are transformed into digital video signals through channel selection, decoding operation and analog-to-digital conversion. The digital video signals are then transmitted to the host 10 and shown on a display 11 of the computer system. By executing an application program installed in the host 10, a user interface 110 is shown on the display 11. An input device such as a mouse device 12 is manipulated to control the user interface 110 so as to achieve the purpose of playing and/or recording TV programs by a computer system.

Referring to FIG. 2, a user interface is exemplified. Among the icons, a recording virtual button 1100 is shown for user's selection when a recording operation is to be performed. The triggered button 1100 enables the execution of the application program to store the TV frames 20 currently and subsequently shown on the display 11 into a hard disc 101 of the computer host 10.

As currently commercialized hard disc has considerable storage capacity, a so-called “time shift” function is developed for increasing recording options. For executing the “time shift” function, the user moves the mouse device 12 and clicks on the time-shift virtual button 1101. In response, the application program defines a buffer zone (not shown) in the hard disc 101 or another kind of memory. The size of the buffer is preset by the system according to the predetermined recording length for the time shift function. For example, the recording length for the time shift function is set to be one hour by the system. It means the buffer is capable of storing frames for one hour from the triggering time point of the time-shift virtual button 1101. After the buffer is fully occupied, the data stored into the time-shift virtual button 1101 at the earliest will be overwritten so that there are always one-hour updated frames stored in the buffer. The “time shift” function is advantageous for filling the time gap when the user is temporarily unavailable to see the currently played TV program. For example, the user leaves where they are watching TV for about 15 minutes and then comes back to continue watching the program, the missing 15-minute program can be made up by using the “time shift” function. The thing that the user needs to do is to drag the virtual sliding bar 1102 with the mouse device 12 to shift 15 minutes back. Then the playback of the recorded program can be done from then on. In this way, the entire program will not be missing but just ends 15 minutes later.

The “time shift” function is also advantageous for unscheduled recording. For example, when the user has been watching a TV program for half an hour and decides to record this program, the 30-minute missing part of the program can still be recorded by using the “time shift” function. Of course, the time-shift virtual button 1101 has to be enabled previously so as to have recorded a certain period of programs. Then the things the user has to do are to drag the virtual sliding bar 1102 with the mouse device 12 to shift the time back to the beginning time of the program, push the recording virtual button 1100 to start recording, and push stop virtual button 1103 to stop recording. Accordingly, the mouse device 12 needs to be manipulated three times to complete the recording operation. It may bother the user, particularly when the user is not comfortable with the computer operations.

### SUMMARY OF THE INVENTION

Therefore, the present invention provides a signal pickup method that allows the unscheduled recording cooperative with the time-shift function can be easily executed.

The present invention also relates to a video recording and playing system capable of executing time-shift function, which uses a signal pickup method to allow the unscheduled recording to be easily executed.

The present invention provides a signal pickup method of a video/audio recording and playing system, comprising steps of: setting a recording length and a tracing-back length; receiving an external signal and storing the external signal into a buffer of the video/audio recording and playing system; and automatically picking up a designated section of the external signal from the buffer according to the recording length and the tracing-back length in response to a triggering operation of a user.

In an embodiment, the designated section of the external signal includes data recorded in the buffer between a start point and a stop point, wherein the start point is the tracing-back length prior to the triggering operation, and the stop point is the recording length after the start point.

In an embodiment, the method further comprises a step of defining the buffer in a storage zone of the video/audio recording and playing system according to the recording length so that the buffer has a size sufficient for storing the designated section of the external signal. The storage zone, for example, is a hard disc or another type of memory.

In an embodiment, the designated section of the external signal is copied from the buffer to a storage zone of the video/audio recording and playing system as a whole.

In an embodiment, the designated section of the external signal is copied from the buffer to a storage zone of the video/audio recording and playing system in segments.

In an embodiment, a first portion of the designated section of the external signal, which has been recorded into the buffer before the triggering operation, is copied from the buffer to the storage zone of the video/audio recording and playing system as a whole, and a second portion of the designated section of the external signal, which has been recorded into the buffer after the triggering operation, is copied from the buffer to the storage zone of the video/audio recording and playing system in real time.

In an embodiment, the triggering operation is implemented by enabling a single button of a user interface of the video/audio recording and playing system, thereby automatically completing the pickup of the designated section of the external signal from the buffer to a storage zone of the video/audio recording and playing system and then stopping further signal pickup.

The present invention further provides a video/audio recording and playing system capable of recording a designated section of an external signal from a start time point prior to the present time point. The system includes a software program including information of a recording length and a tracing-back length and executed to have an external signal continuously stored into a buffer, wherein the tracing-back length is a length prior to the present time point for defining a start time point, and the recording length is a length from the start time point for defining a stop time point; and an input device manipulated by a user to execute the software program to automatically pickup only a designated section of the external signal recorded in the buffer from the start time point to the stop time point.

In an embodiment, the system further includes a user interface. The user interface includes a recording trigger button. The input device is manipulated by the user to enable the recording trigger button.

In an embodiment, the designated section of the external signal recorded in the buffer is automatically picked up and stored into a hard disc of the video/audio recording and playing system as a file by enabling only the recording trigger button.

In an embodiment, the input device is a cursor control device and the recording trigger button is a virtual button shown on a display of the video/audio recording and playing system.]

In an embodiment, the input device is a remote controller and the recording trigger button is a push button disposed on the remote controller.

In an embodiment, the buffer is defined in a storage zone of the video/audio recording and playing system by executing the software program. In this embodiment, the buffer may have a size substantially equal to the size of the designated section of the external signal.

In an embodiment, the buffer is a circular buffer.

In an embodiment, the recording length and the tracing-back length are preset by the video/audio recording and playing system.

In an embodiment, the recording length and the tracing-back length are preset by a user via the user interface.

In an embodiment, the software program is an application program executable in a TV tuner card or a TV box.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a functional block diagram illustrating a computer system that is capable of playing TV programs;

FIG. 2 is a schematic diagram showing a TV frame and a conventional user interface for processing the TV frame;

FIG. 3 is a flowchart summarizing a signal pickup method according to an embodiment of the present invention;

FIG. 4A is a functional block diagram illustrating a computer system where the signal pickup method according to the present invention is applicable;

FIG. 4B is a schematic diagram showing a TV frame and a user interface in cooperation with a signal pickup method for processing the TV frame according to the present invention;

FIGS. 5A˜C are schematic diagrams illustrating a circular buffer for facilitating the execution of the signal pickup method according to the present invention, which is marked with different recording-related points; and

FIG. 6 is a functional block diagram illustrating a digital recorder system where the signal pickup method according to the present invention is applicable.

### DETAILED DESCRIPTION OF THE PREFERRED EMBODIMENT

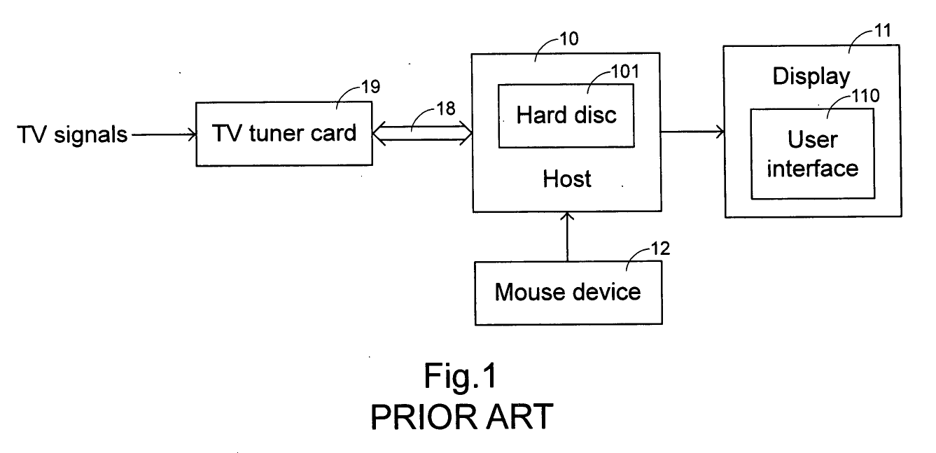

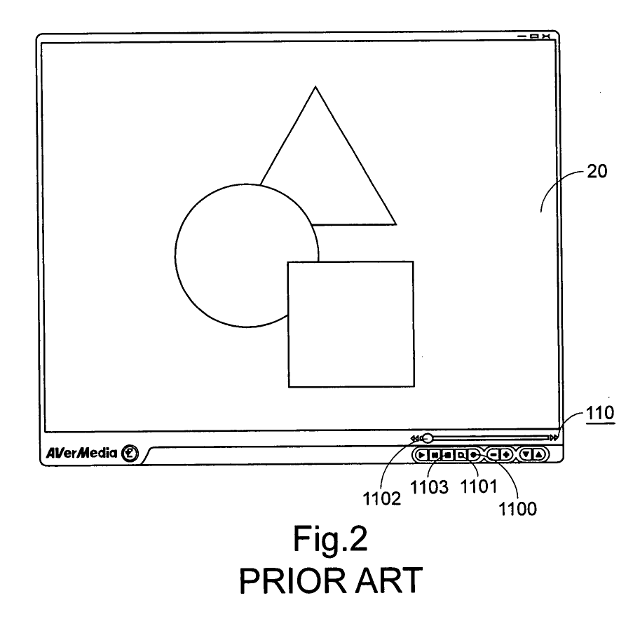

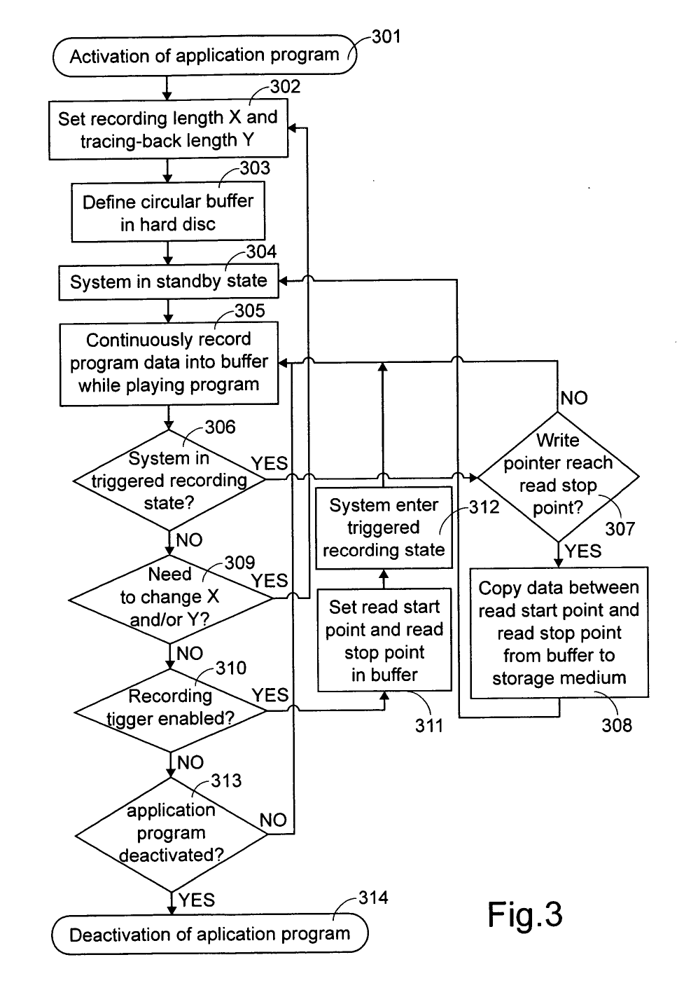

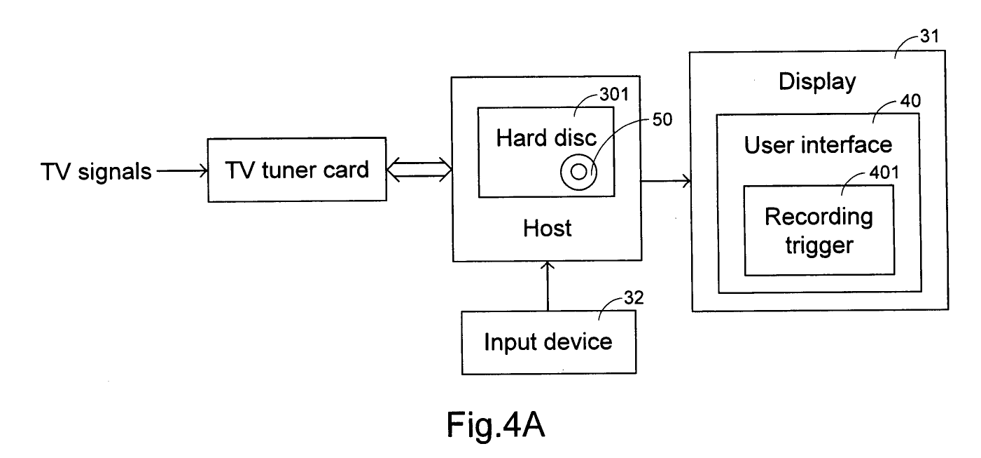

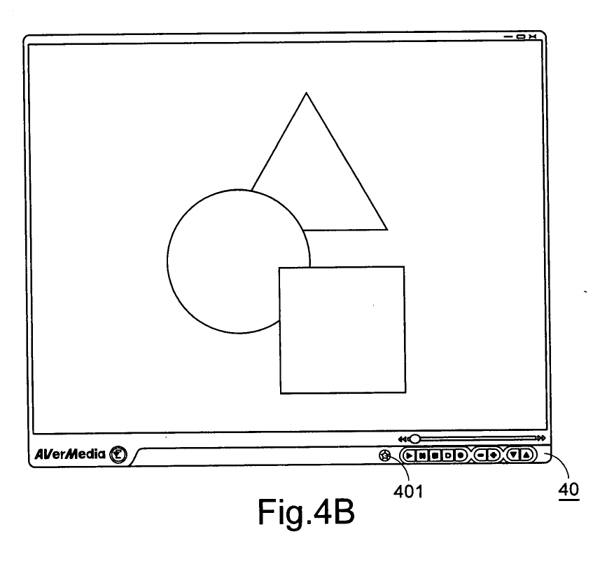

Please refer to FIG. 3. An embodiment of a signal pickup method according to the present invention is applicable to a computer system capable of playing an analog TV program, as shown in FIG. 4A. The computer system is similar to the one shown in FIG. 1, but the software program such as application program executed in the computer system for playing and processing the analog TV program is modified. In response to the execution of the application program, a frame and a user interface 40 comprising of a plurality of virtual buttons are shown on the display 31 (FIG. 4B). The virtual buttons can be similar to those of FIG. 2 except that a recording trigger 401 is added. The virtual buttons 40 can be enabled by moving a cursor on the display 31 to the selected button with an input device 32 and then activate the input device 32. For example, the input device 32 can be a mouse device, and one of the click switches of the mouse device can be triggered when the cursor has been moved to the selected button, thereby enabling the selected function.

The present signal pickup method starts with the activation of the application program (Step 301). The software program is an application program executable in a TV tuner card or a TV box. Then, recording length X and tracing-back length Y are preset by the system or the user and recorded in the system (Step 302). According to the recording length X and the tracing-back length Y, it is understood that the program played between a time point that is a length Y prior to the present time point and another time point that is a length (X-Y) after the present time point are to be recorded. It is apparent that Y should be no greater than X. According to the recording length X, a circular buffer 50 (FIG. 3B) having a sufficient size for storing the program played during the recording length X is defined in the hard disc 301 or other memory (Step 303) by the system. The circular buffer 50 is just an example of buffer that is applicable to the present invention, and any other suitable buffer can be used as well.

Afterwards, the system stays in a standby state (Step 304) and continuously records program data into the buffer 50 while playing the program (Step 305). The stored data will be overwritten with newly recorded data after the buffer 50 has bee fully occupied.

If the recording trigger 401 has not been enabled, the user can still change preset recording length X and the tracing-back length Y (Steps 306 and 309). If the recording trigger 401 is enabled with the input device 32 (Step 310), it is realized that permanent recording operation rather than temporary recording is to be executed. Therefore, a read start point and a read stop point are determined according to the recording length X and tracing-back length Y (Step 311), and a triggered recording operation is performed (Step 312). Meanwhile, a write pointer indicating data recording into the buffer 50 proceeds, and whether the writer pointer reaches the read stop point is determined (Step 307). It is understood the read start point, read stop point and write pointer can be expressed as time or address or position in the buffer, which are correlated to each other. If the read stop point is reached, i.e. the recording length X is due, the data recorded in the buffer 50 within the designated period are duplicated from the buffer 50 to a desired storage medium such as the hard disc 301 or an optical disc (not shown) (Step 308). It is of course that data recorded in the buffer 50 can also be transferred to the storage medium while the recording of the desired program into the buffer is still being performed. Alternatively, the data having been recorded in the buffer 50 before the present time are transferred to the storage medium first, and then the newly received data are synchronously transferred to the storage medium in real time. Afterwards, the system enters the standby state again. The above steps are optionally executed until the application program is deactivated (Steps 313 and 314). Before the deactivation of the application program, the program is continuously recorded and updated in the buffer 50 (Steps 313 and 305).

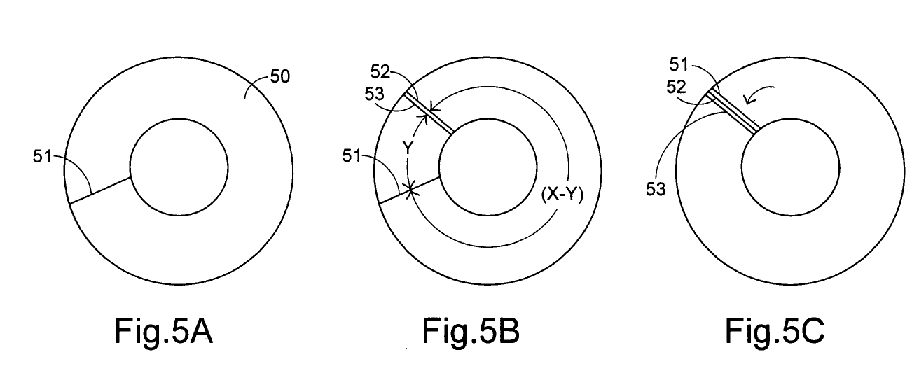

In the embodiment illustrated in the above flowchart, the read start point and the read stop point are both determined to define the data range to be copied to the storage medium. Nevertheless, the read stop point can also serve as the read start point if the buffer size is defined to be substantially equal to the recording length X. Examples can be seen in FIGS. 5A˜5C.

Referring to FIG. 5A, a write pointer 51 indicative of the present recording time in the circular buffer 50 is shown. Then, according to the recording length X and the tracing-back length Y, a read start point 53 and a read stop point 52 which are substantially identical are defined, as shown in FIG. 5B. The write pointer 51 then moves with the buffer-recording operation, as indicated by the counterclockwise arrow, until the read stop point 52 is reached as shown in FIG. 5C. Then the data of the program played between a time point that is a period Y prior to the present time and a time point that is a period (X-Y) after the present time are copied to the desired storage medium as a video file. For example, if the recording length X is set to be 20 minutes and the tracing-back length Y is set to be 5 minutes, it means the data stored into the buffer 5 minutes ago through the data stored into the buffer 15 minutes later would like to be copied to the storage medium.

In the above embodiment, a computer system is used to exemplify the signal pickup device according to the present invention. Nevertheless, the present method can also be used in other video/audio recording and playing systems. Furthermore, a mouse device is exemplified as the input device and clicked to enable the recording trigger 401. Alternatively, other input devices such as remote controller, touch panel, keyboard or microphone can also be used to enable the recording trigger 401. Moreover, in spite a virtual button for triggering a recording operation is included in the user interface, the triggered recording can also be enabled by pushing physical button or buttons. A key or key combination on the keyboard and a push button on the remote controller are some of the examples.

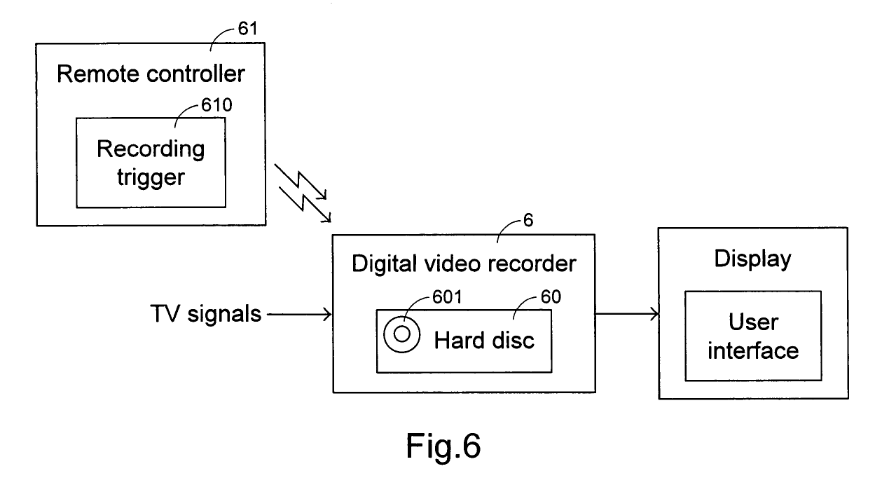

FIG. 6 illustrates a digital recorder system where the signal pickup method according to the present invention is applicable. In this embodiment, the recording trigger 610 is disposed on the remote controller 61 and the buffer 601 for time-shift and triggered recording purposes is included in the hard disc 60 of the digital recorder system 6. The operational principle is similar to that described above.

In addition to analog TV signals, the present invention is also applicable to the pickup of other analog or digital signals such as video signals, image signals, audio signals or radio signals transmitted to the system wirelessly or via a cable. Correspondingly, a video or audio recording and playing system is used to run the signal pickup method. The analog signals, nevertheless, need to be converted into digital signals before being processed by a digital video/audio recording and playing system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A signal pickup method of a video/audio recording and playing system, comprising:
setting a recording length and a tracing-back length;
receiving an external signal and storing said external signal into a buffer of the video/audio recording and playing system; and
automatically picking up a designated section of said external signal from said buffer according to said recording length and said tracing-back length in response to a triggering operation of a user.

2. The method according to claim 1 wherein said designated section of said external signal includes data recorded in said buffer between a start point and a stop point, wherein said start point corresponds to said tracing-back length prior to said triggering operation, and said stop point follows said start point by corresponding to said recording length.

3. The method according to claim 1 further comprising a step of defining said buffer in a storage zone of the video/audio recording and playing system according to said recording length so that said buffer has a size sufficient for storing said designated section of said external signal.

4. The method according to claim 1 wherein said storage zone is a hard disc or a memory.

5. The method according to claim 1 wherein said designated section of said external signal is picked up and copied from said buffer to a storage zone of the video/audio recording and playing system as a whole in response to said triggering operation of the user.

6. The method according to claim 1 wherein said designated section of said external signal is picked up and copied from said buffer to a storage zone of the video/audio recording and playing system in sequence in response to said triggering operation of the user.

7. The method according to claim 6 wherein a first portion of said designated section of said external signal, which has been recorded into said buffer before said triggering operation, is copied from said buffer to said storage zone of the video/audio recording and playing system as a whole, and a second portion of said designated section of said external signal, which is recorded into said buffer after said triggering operation, is copied from said buffer to said storage zone of the video/audio recording and playing system in real time.

8. The method according to claim 1 wherein said tracing-back length is equal to or shorter than said recording length.

9. The method according to claim 1 wherein said triggering operation is implemented by enabling a single button of a user interface of the video/audio recording and playing system, thereby automatically completing the pickup of said designated section of said external signal from said buffer to a storage zone of the video/audio recording and playing system and then automatically stopping further signal pickup.

10. A video/audio recording and playing system capable of recording a designated section of an external signal from a start time point prior to the present time point, comprising:
a software program including information of a recording length and a tracing-back length and executed to have an external signal continuously stored into a buffer, wherein said tracing-back length is a length prior to the present time point for defining a start time point, and said recording length is a length from said start time point for defining a stop time point; and
an input device manipulated by a user to have said software program automatically pick up only a designated section of said external signal recorded in said buffer from said start time point to said stop time point.

11. The system according to claim 10 further comprising a user interface that includes a recording trigger button, wherein said input device is manipulated by the user to enable said recording trigger button.

12. The system according to claim 11 wherein said designated section of said external signal recorded in said buffer is automatically picked up and stored into a hard disc of the video/audio recording and playing system as a file by enabling only said recording trigger button.

13. The system according to claim 11 wherein said input device is a cursor control device and said recording trigger button is a virtual button shown on a display of the video/audio recording and playing system by executing said software program.

14. The system according to claim 11 wherein said input device is a remote controller and said recording trigger button is a push button disposed on said remote controller.

15. The system according to claim 10 wherein said buffer is defined in a storage zone of the video/audio recording and playing system by executing said software program.

16. The system according to claim 15 wherein said buffer has a size substantially equal to the size of said designated section of said external signal.

17. The system according to claim 10 wherein said buffer is a circular buffer.

18. The system according to claim 10 wherein said recording length and said tracing-back length are preset by the video/audio recording and playing system.

19. The system according to claim 10 wherein said recording length and said tracing-back length are preset by a user via said user interface.

20. The system according to claim 10 wherein said software program is an application program executable in a TV tuner card or a TV box.
